(19) United States
(12) Patent Application Publication
(10) Pub. No.: US 2016/0028957 A1
(43) Pub. Date: Jan. 28, 2016

(54) IMAGING DEVICE, A CONTROL METHOD FOR TRANSMITTING PICTURE SIGNALS, AND A PROGRAM

(71) Applicants: SINTAI OPTICAL (SHENZHEN)CO., LTD., Shenzhen City (CN); ASIA OPTICAL CO., INC., Taichung City (TW)

(72) Inventor: Kunihiko Kanai, Taichung City (TW)

(21) Appl. No.: 14/808,093

(22) Filed: Jul. 24, 2015

(30) Foreign Application Priority Data
Jul. 24, 2014 (JP) 2014-151137

(51) Int. Cl. H04N 5/232

(52) U.S. Cl. CPC H04N 5/23267; H04N 5/23258; H04N 5/23296; H04N 5/23245; H04N 5/23238

(57) ABSTRACT

An imaging device including an image mode determining unit, a reading method setting unit, and a control unit is provided. The image mode determining unit determines an image mode among a plurality of image modes corresponding to the position or angle of the imaging device. The reading range setting unit sets the reading range for the image sensor to correspond with the image mode determined by the image mode determining unit. The control unit temporarily stores pixel data in a frame buffer based on the output picture signal in association with the output of a picture signal which is obtained by optic-electrical conversion from the image sensor according to the reading range based on the setting of the reading range setting unit.

### CROSS REFERENCE TO RELATED APPLICATIONS

This Application claims priority of Japan Patent Application No. 2014-151137 filed on Jul. 24, 2014, the entirety of which is incorporated by reference herein.

### BACKGROUND OF THE INVENTION

1. Field of the Invention

There are usually many image modes, and cameras that are capable of obtaining images or pictures corresponding to the various image modes are well known (for example, see Reference Document 1).

2. Description of the Related Art

Regarding the camera illustrated in Reference Document 1, the motion of the device itself is determined by the contact with the motion-inspecting switch and the switch press protuberance in accordance with the various departing states from the maintaining component and a plurality of motional positions, and it is composed for outputting and executing the image correction by a plurality of image modes corresponding to the motion.

### THE PRIOR ART

Reference Document 1: JP 2009-015313

### BRIEF SUMMARY OF THE INVENTION

### The Problem to be Solved

However, regarding the camera illustrated in Reference Document 1, the picture signal output from the image sensor is overall transmitted to the frame buffer and is temporarily stored in it. The following implementation of picture symbolization processing or error correction is well-known. Accordingly, regarding the picture signal that is output and imaged utilizing a wide-angle lens such as a fish-eye lens, the memory size for just the overall picture data which is based on the picture signal to be temporarily stored must be in the frame buffer. In addition, when dynamic-image symbolization is executed on the image frame temporarily stored in the frame buffer for becoming a dynamic-image stream, the image frame is so big that the frame rate is low. Furthermore, when correction processing is performed in such a way that corresponds to the switching of image modes, the image frame is so big that it takes time to automatically switch between image modes.

In order to solve any of the above problems, an imaging device, a control method for transmitting picture signals and a program are provided in order to obtain suitable picture signals corresponding to the image mode.

### The Method for Solving the Problem

In one aspect of the invention, an imaging device including an image mode determining unit, a reading range setting unit and a control unit is provided. The image mode determining unit determines an image mode among a plurality of image modes corresponding to the position or angle of the imaging device. The reading range setting unit sets the reading range for the image sensor to correspond with the image mode determined by the image mode determining unit. The control unit temporarily stores pixel data in a frame buffer based on the output picture signal in association with an output of a picture signal which is obtained by optic-electrical conversion from the image sensor according to the reading range based on the setting of the reading range setting unit.

In addition to the above composition, the imaging device includes a wide-angle lens capable of omni-directional imaging. The image mode determining unit corresponds to the position or angle of the imaging device, and determines either an omni-directional image mode capable of omni-directional imaging or the usual image mode capable of imaging with a viewing angle that is narrower than that of the omni-directional image mode. When the image mode determining unit determines that the usual image mode is to be used, the reading range setting unit sets the reading range of a pixel from the image sensor included in a determined range, wherein the range is narrower than the omni-directional viewing angle. When the omni-directional image mode is chosen, it maintains the omni-directional viewing angle, and sets the reading range for executing intermittent processing or adding operations so that the data size is the same or approximately the same as the data size determined by the reading range of the usual image mode. The control unit, in association with an output of the picture signal which is obtained by optic-electrical conversion from the image sensor according to the setting of the reading range setting unit, temporarily stores the pixel data in the frame buffer based on the output picture signal.

In another aspect of the invention, a control method for transmitting a picture signal is provided. The control method is utilized for an imaging device including an image mode determining unit, a reading range setting unit, a control unit, an image sensor and a frame buffer. The control method includes the step of determining an image mode among a plurality of image modes corresponding to the position or angle of the imaging device by the image mode determining unit; the step of setting a reading range for an image sensor by the reading range setting unit corresponding to the image mode determined in the image mode determining step; and the step of in association with an output of a picture signal which is obtained by optic-electrical conversion from the image sensor based on the step of setting the reading range, temporarily storing pixel data in a frame buffer based on the output picture signal.

In another aspect of the invention, a program is provided which is utilized for implementing functions on a computer. The program includes an operation for determining an image mode among a plurality of image modes corresponding to the position or angle of an imaging device; an operation for setting a reading range for an image sensor corresponding to the image mode determined in the image mode determining operation; and an operation for in association with an output of a picture signal which is obtained by optic-electrical conversion from the image sensor according to the reading range based on the operation for setting the reading range, temporarily storing pixel data in a frame buffer based on the output picture signal.

In another aspect of the invention, the imaging device includes an acceleration sensor, and the position or the angle of the imaging device is obtained by calculation of the acceleration sensor. When the image mode determining unit determines that an imaging direction of the imaging device is orthogonal to a horizontal direction or has the same inclination, the image mode is determined to be an omni-directional mode. When the image mode determining unit determines that an imaging direction of the imaging device is identical to a horizontal direction or has the same inclination, the image mode is determined to be an usual mode. When the image mode is determined to be the omni-directional mode, it has the inclination within a range of 45-degree toward left and right inclination in contrast with the orthogonal to the horizontal direction. When the image mode is determined to be a front mode, it has the inclination within a range of 45-degree inclination in contrast with the horizontal direction.

In still another aspect of the invention, the imaging device further includes an operation unit to set the reading range of the image sensor and directly transmit the reading range of the image sensor to the control unit. In addition, the image mode could be determined to be the omni-directional mode or the front mode through the operation unit. The imaging device comprises a wide-angle lens capable of omni-directional (360-degree) imaging; the image mode determining unit corresponds to the position or angle of the imaging device; and determines either an omni-directional image mode capable of omni-directional imaging or a usual image mode capable of imaging with a viewing angle that is narrower than that of the omni-directional image mode.

In still another aspect of the invention, the reading range setting unit, when the usual image mode is determined by the image mode determining unit, sets the reading range for a pixel from the image sensor included in a determined range which is narrower than an omni-directional viewing angle, and when the omni-directional image mode is determined, maintains the omni-directional viewing angle, and sets the reading range for executing intermittent processing or adding operation so that the data size is the same or approximately the same as the data size determined by the reading range of the usual image mode. In addition, the control unit, in association with an output of the picture signal which is obtained by optic-electrical conversion from the image sensor according to the setting of the reading range setting unit, temporarily stores the pixel data in the frame buffer based on the output picture signal.

### The Effect of the Present Invention

The present invention provides an imaging device, a control method for transmitting picture signals, and a program which is capable of obtaining suitable picture signals corresponding to the image mode.

### BRIEF DESCRIPTION OF DRAWINGS

The invention can be more fully understood by reading the subsequent detailed description and examples with references made to the accompanying drawings, wherein:

FIG. 1 is a block diagram illustrating the hardware composition of the imaging device 1 according to an embodiment of the present invention;

FIG. 2 is a block diagram illustrating the functional composition of the control unit 6 of the imaging device 1 as shown in FIG. 1;

FIG. 3(A) and FIG. 3(B) illustrate the two reading ranges of the image sensor 12 included by the imaging device of FIG. 1 and include the diagrams for an exemplary embodiment of the following extension and processing. FIG. 3(A) includes diagrams illustrating an exemplary embodiment of extension and processing after the reading range of the image sensor 12 in the round mode. FIG. 3(B) includes diagrams illustrating an exemplary embodiment of extension and processing after the reading range of the image sensor 12 in the front mode.

FIG. 4(A) and FIG. 4(B) are diagrams illustrating the embodiment of the image mode, and illustrating the relationship with the reading range of the image sensor 12 when the motion of the imaging device 1 of FIG. 1 changes. FIG. 4(A) is a diagram illustrating an embodiment of the motion of the imaging device 1 in the round mode. FIG. 4(B) is a diagram illustrating the embodiment of the motion of the imaging device 1 in the front mode.

FIG. 5 is a block diagram illustrating the hardware composition of the imaging device 1A according other embodiments of the present invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The Hardware Composition of the Imaging Device 1

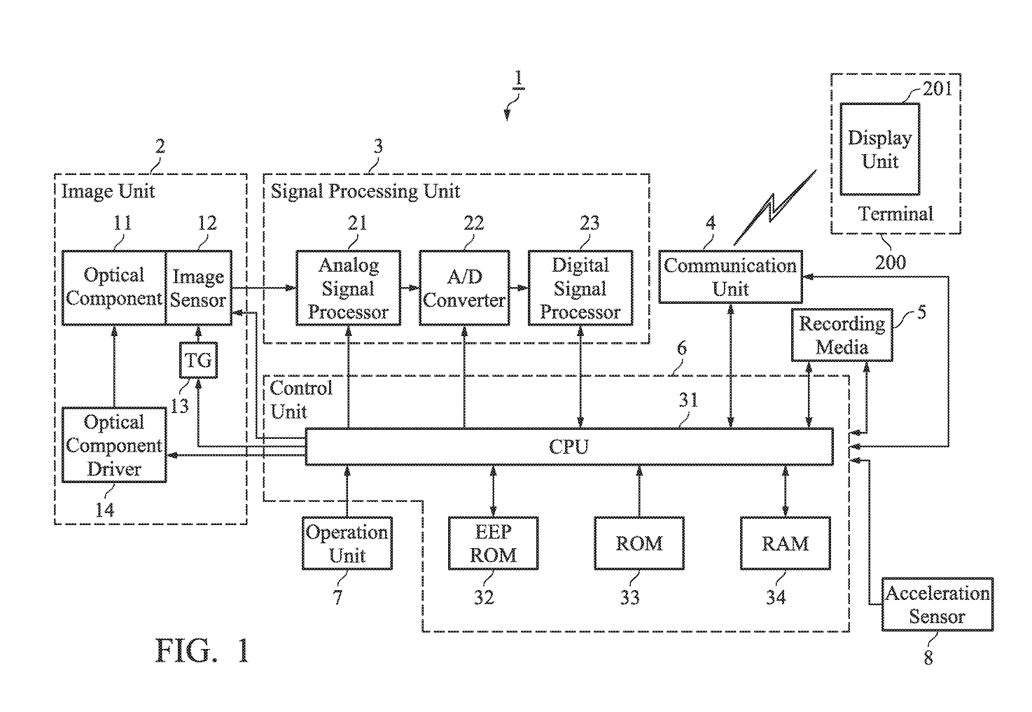

FIG. 1 is a block diagram illustrating the hardware composition of the imaging device 1 according to an embodiment of the present invention. For example, the imaging device 1 includes a wide-angle lens capable of omni-directional (360 degrees) imaging (or fish-eye lens), and includes a device such as a digital still camera or a digital video camera capable of dynamic imaging or taking a still image. Furthermore, the imaging device 1 could, for example, be utilized to adjust and fix the expecting direction of the image direction of the imaging device 1 using an apparatus for fitting up the head of a person or a mountain bike (i.e. mount), for example. The imaging device 1 captures an image of the subject and obtains the imaging picture (this could be a still picture or a dynamic picture) according to the image. In addition, the imaging device 1 can transmit and indicate the picture data recorded in the recording media to the external terminal. Furthermore, the imaging device 1 could be implemented by a digital camera, but it is not limited thereto. It could be any electronic device capable of imaging functionality. In addition, it is not necessary for the imaging device 1 to be a device capable of omni-directional (360 degrees) imaging.

As illustrated in FIG. 1, the imaging device 1 includes the image unit 2, the signal processing unit 3, the communication unit 4, the recording media 5, the control unit 6, the operation unit 7 and the acceleration sensor 8.

The image unit 2 captures an image of the subject and outputs the analog picture signal. The image unit 2 includes the image optical component 11, the image sensor 12, the TG (Timing Generator) 13 and the optical component driver 14.

The image optical component 11 could be various kinds of focus lens and zoom lens, or an optical filter for eliminating un-desired wavelength, or an optical component such as a diaphragm. The optical image incident from the subject (the subject image) passes through various optical components on the image optical component, and an optical image is formed on the light-exposure surface of the image element 12. Furthermore, the image optical component 11 mechanically connects to the optical component driver 14 for driving the optical components.

For example, the image sensor 12 is composed of solid image sensors such as CCD (Charge Coupled Device) or CMOS (Complementary Metal Oxide Semiconductor). Each pixel of the image sensor 12 receives light from the image subject through the color filter and converts between optics and electrics. The image sensor 12 outputs the picture signal as the accumulation of charges of each pixel. The picture signal output by the image sensor 12 is input to the signal processing unit 3. In addition, the color filter is the original-color Bayer layout composed of the three colors of R, G, B, or the complementary-color Bayer layout composed of the four colors of C, M, Y, G, and it is placed in the color pattern of a periodical layout, which lays out the m×n pixels as a unit. By utilizing the color filter, the image based on the picture signal becomes the color picture (the picture data based on the picture signal is called a RAW picture in the following descriptions).

In addition, the image sensor 12 can output the picture signal which is obtained by the optic-electricity conversion by the reading range corresponding to the two image modes. Specifically, when the image sensor 12 reads the charge (the luminosity value), it is narrower than the omni-directional viewing angle, and the omni-directional viewing angle is maintained as the reading range of the pixel from the image sensor which is included in the determined range. In order to obtain the data size, which is the same or approximately the same as the reading situation of the above reading range, the reading range can be set for implementing either the intermittent operation or the adding operation. When the reading range for the pixel is set which is from the image sensor included in the determined range, the image sensor 12 outputs the read pixel from the area within the determined range. Accordingly, the data number of the RAW image output from the image sensor can be compared with the reading situation of the pixel from the omni-directional angle and be reduced. Furthermore, the determined range of reading the pixel of the image sensor 12 could be predetermined, or could be constructed by the setting according to the operation unit 7 which is operated by the user.

In addition, the reading range of the image sensor 12 can be switched according to the imaging mode. In the usual imaging mode (this imaging mode is called “front mode” in the following description), which is narrower than the omni-direction (360 degree), the reading range of the area of the determined range is set by the image sensor 12, and the image sensor 12 is read out, which includes the area of the determined range from the overall image sensor 12. On the other hand, in the imaging mode capable of omni-directional (360 degree) imaging (this imaging mode is called “round mode” in the following description), the omni-directional viewing angle is maintained, the reading range can be set for implementing either the intermittent operation or the adding operation in order to obtain the data size which is the same or approximately the same as the reading situation of the round mode, and the picture is read out in the maximum viewing angle from the overall image sensor 12. Accordingly, in the imaging device 1, the determined data size could be obtained by both the front mode and the round mode. When the same data size is provided, the round mode can obtain a more sophisticated image than the front mode.

The TG 13 generates necessary pulses for the image sensor 12 according to the instruction of the control unit 6. For example, in order to provide the image sensor 12, the TG 13 generates various pulses, such as the four-phase pulse for vertical transmission, the field-shift pulse, the two-phase pulse for horizontal transmission, and the shutter pulse.

The optical component driver 14 includes, for example, the zoom motor, the focus motor, and the diaphragm adjusting apparatus to move the zoom lens and the focus lens and adjust the diaphragm. Furthermore, the optical component driver 14 drives the image optical component 11 according to the instruction of the control unit 6 illustrated below.

The signal processing unit 3 implements the determined signal processing on the picture signal output from the image sensor 12, and outputs the processed picture signal to the control unit 6. The signal processing unit 3 includes the analog signal processor 21, the analog-to-digital (A/D) converter 22 and the digital signal processor 23.

The analog signal processor 21 performs the front-processing on the picture signal which is also called the analog front end. For example, the analog signal processor 21 performs the gain processing on the picture signal output from the image sensor by means of the CDS (Correlated Double Sampling) processing and the PGA (Programmable Gain Amplifier).

The A/D converter 22 converts the analog picture signal input from the analog signal processor 21 to the digital picture signal, and outputs it to the digital signal processor 23.

The digital signal processor 23 performs the digital signal processing on the input digital picture signal such as noise elimination, white balance adjusting, color compensation, edge emphasizing, and gamma compensation, and outputs it to the control unit 6.

The communication unit 4 functions as a communication interface in order to transmit the digital picture signal to other information processing devices (for example, a tablet terminal, smartphone, or personal computer). Furthermore, the digital picture signal which is input through the communication unit 4 is displayed on the display unit 201 of the external terminal 200 described below.

The recording media 5 records various data such as data of the above imaging picture and the meta-data. For example, the recording media 5 can utilize the semiconductor memory such as a memory card, or utilize disk-type recording media such as an optical disk or a hard disk. In addition, the optical disk may, for example, be a blue-ray disk, a DVD (digital versatile disk), or a CD (compact disc). Furthermore, the recording media 5 could be embedded in the imaging device 1, or could be removable media which is capable of attaching to and being removed from the imaging device 1.

The control unit 6, for example, is composed of a microcontroller to control the overall operation of the imaging device 1. By way of example, the control unit 6 includes the CPU 31, the EEPROM (Electrically Erasable Programmable ROM) 32, the ROM (Read-Only Memory) 33 and the RAM (Random Access Memory) 34. In addition, the ROM 33 is utilized to store the program for performing various controlling and processing on the CPU 31. The CPU 31 operates based on the above program, expands the data in the RAM 34, and executes the necessary algorithm for commanding and processing of the above controlling. The above program can be pre-stored in the memory device (for example, the EEPROM 32, the ROM 33 and so on) which is embedded within the imaging device 1. Furthermore, the above program could be stored in removable recording media such as a disk-type recording media or memory card, and be provided to the imaging device 1, or it could be downloaded to the imaging device 1 through a network such as the LAN or the Internet.

The operation unit 7 functions as a user interface. For example, the operation unit 7 is composed of various operation keys such as a button and a label, or a touch panel, and outputs instruction information to the control unit 6 corresponding to the user operation.

The acceleration sensor 8 is utilized to inspect the acceleration when the imaging device 1 functions. For example, the acceleration sensor 8 is composed of a three-axis acceleration sensor for inspecting the acceleration of the imaging device 1 in the front-and-back direction, the left-and-right direction, and the up-and-down direction. The three-axis acceleration is inspected when the imaging device 1 functions. The acceleration sensor 8 outputs the acceleration information illustrating the inspected three-axis acceleration to the control unit 6. In addition, a one-axis or two-axis acceleration sensor 8 could be utilized to inspect the rotation angle of the imaging device 1 in one or two directions, and it could be capable of calculating the imaging direction. However, the three-axis acceleration sensor 8 could be utilized to calculate the imaging direction more precisely. Therefore, it is preferable to utilize a three-axis acceleration sensor 8. The control unit 6 utilizes the inspection value (the acceleration information) of the acceleration sensor 8, and is capable of calculating the imaging direction and the motion (the position and the angle) of the imaging device 1.

Furthermore, the above imaging direction includes the horizontal direction of the imaging direction when the subject image is captured by the imaging device 1. For example, the imaging direction can illustrate the rotation angle θ (θ is 0˜360 degrees) which indicates an incline from the determined base axis. Furthermore, the imaging direction includes the optical-axis direction of the above imaging optical component 11.

The Functional Composition of the Imaging Device 1

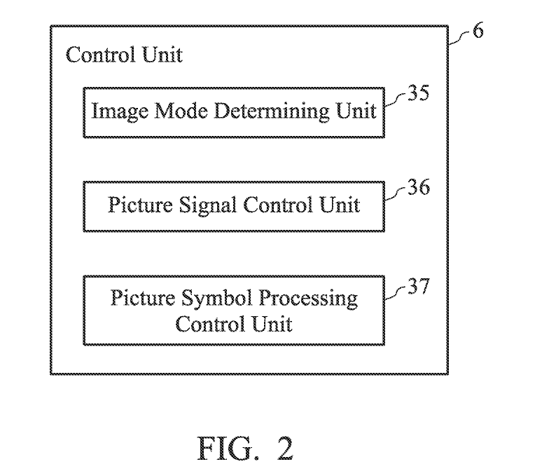

FIG. 2 is a block diagram illustrating the functional composition of the control unit 6 of the imaging device 1 as shown in FIG. 1. As shown in FIG. 2, the control unit 6 of the imaging device 1 includes the image mode determining unit 35, the picture signal control unit 36 and the picture symbol processing control unit 37.

The image mode determining unit 35 determines the image mode from the imaging direction of the imaging device 1 based on the acceleration information which illustrates the three-axis acceleration inspected by the acceleration sensor 8. For example, when the imaging direction of the imaging device 1 is facing up or down (the vector is orthogonal to the horizontal direction) or when the same incline can be determined, the image mode determining unit 35 sets the image mode to round mode. In addition, when the imaging direction of the imaging device 1 is consistent with the horizontal direction or when the same incline can be determined, the image mode determining unit 35 sets the image mode to front mode. Furthermore, regarding the determination of the same incline, for example, it could be the within the range of forty-five degrees of the left and right side from a direction which is orthogonal to the horizontal direction, or it could be within the range of forty-five degrees of the horizontal direction. However, it is not limited to the range within forty-five degrees. In addition, the image mode determining unit 35 determines the image mode from the imaging direction of the imaging device 1 based on the acceleration information which illustrates the three-axis acceleration inspected by the acceleration sensor 8. In another embodiment, regardless of the imaging direction of the imaging device 1, the image mode could be set by the user to round mode or front mode using the operation unit 7.

The picture signal control unit 36 controls the digital signal processor 23, switches the operation mode along with the switching of the reading range of the image sensor 12 when the image mode is changed, and performs the determined signal processing (digital picture processing) on the picture signal (RAW picture) which is output from the image sensor 12. For example, the picture signal control unit 36 controls the digital signal processor 23, converts the picture signal (RAW signal) into the YUV signal including the color picture signal which is composed of the luminosity Y component, the color-difference U component and the V component, and outputs the YUV signal. According to the output, the picture signal of the YUV signal output in the period of a frame becomes the composition of one picture. Such composition of picture is called the image frame 11 in the following description.

The picture symbol processing control unit 37 controls the digital signal processor 23, executes the dynamic-image symbolization processing prepared by H.264/AVC (Advanced Video Coding), for example, symbolizes the image frame 11 output from the digital signal processor 23, and outputs it as a dynamic-image stream.

Such functional units can be implemented by executing the program stored in the CPU 31, the ROM 33 and so on as shown in FIG. 1. However, it is not limited thereto. It could also be implemented by specific hardware.

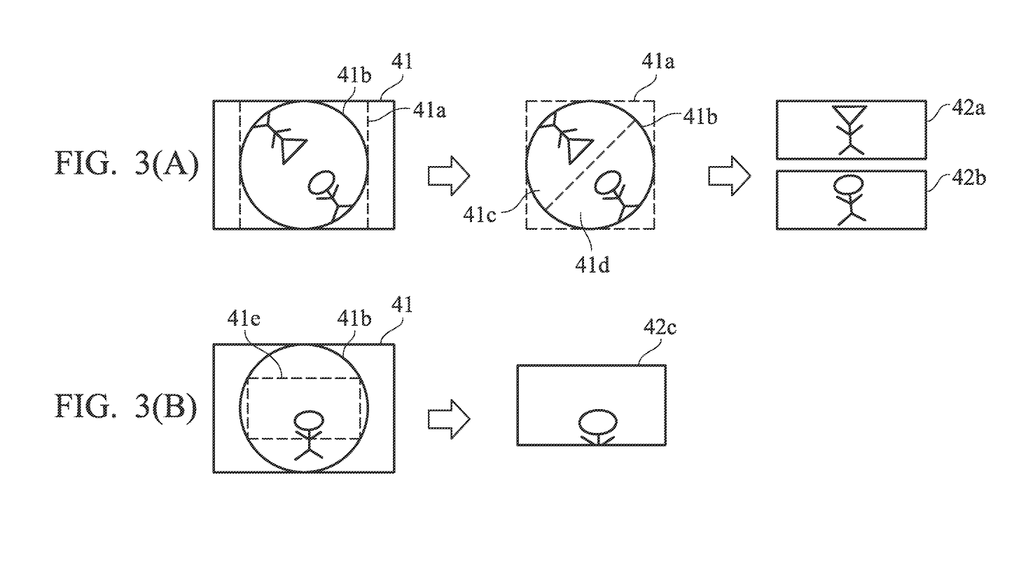

FIG. 3(A) and FIG. 3 (B) illustrate the two reading ranges of the image sensor 12 included by the imaging device of FIG. 1 and include the diagrams for an exemplary embodiment of the following extension and processing. FIG. 3(A) has diagrams illustrating an exemplary embodiment of the extension and processing after the reading range of the image sensor 12 in the round mode. FIG. 3(B) has diagrams illustrating an exemplary embodiment of the extension and processing after the reading range of the image sensor 12 in the front mode.

According to the illustration of FIG. 3(A), the reading area 41a within the viewing angle area 41 is predetermined by the reading range of the image sensor 12 in the round mode. Accordingly, the pixel adding, the intermittent processing of the pixel, and so on, are executed in order to obtain the determined data size (which is the same or approximately the same as the read data size in the following front mode) toward the reading area 41a, and a round picture 41b is extracted which maintains the panorama viewing angle after the execution. Furthermore, the round picture 41b is divided into the semi-round pictures 41c and 41d to generate the rectangular pictures 42a and 42b. In addition, the rectangular pictures 42a and 42b could be displayed as a scroll of one panorama picture, or could be individually displayed as two separate rectangular pictures.

On the one hand, as illustrated in FIG. 3(B), the reading subject area 41e within the viewing angle area 41 is predetermined by the reading range of the image sensor 12 in the front mode. The reading area 41e is narrower than the reading area 41a of FIG. 3A. For example, it is set as the range suitable for a person. Afterwards, the rectangular picture 42c is generated based on the reading area 41e. In addition, the pixel adding, the intermittent processing of the pixel, and so on, could be executed on the reading area 41e in order to generate a rectangular picture 42c.

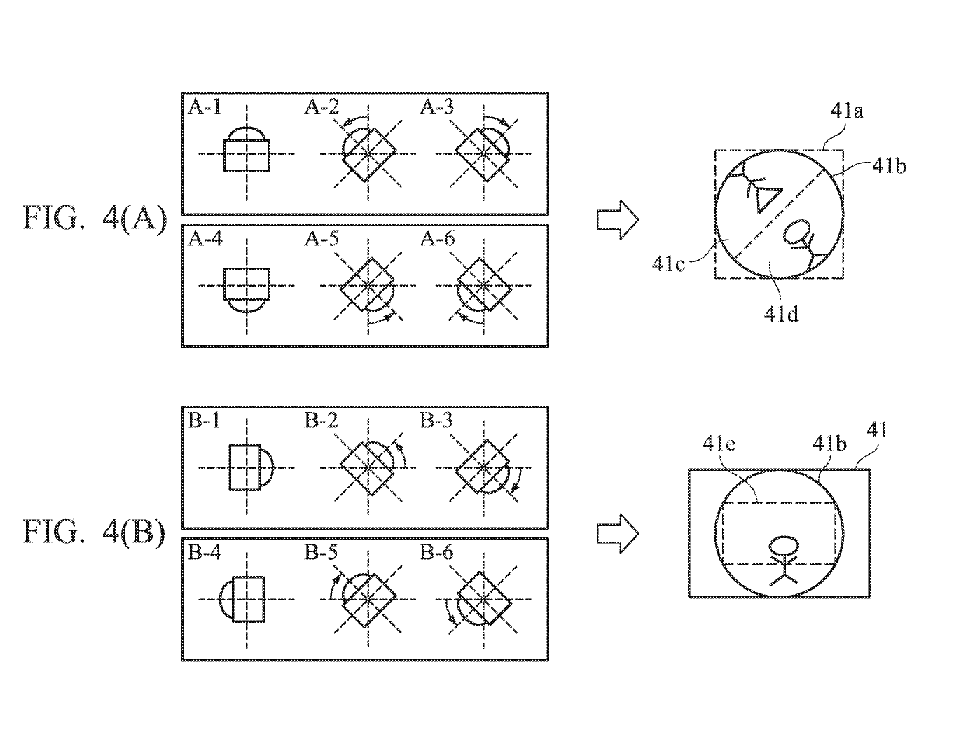

FIG. 4(A) and FIG. 4(B) are diagrams illustrating the embodiment of the image mode and the relationship with the reading range of the image sensor 12 when the motion (position or angle) of the imaging device 1 of FIG. 1 changes. FIG. 4(A) is a diagram illustrating the embodiment of the motion (position or angle) of the imaging device 1 in the round mode, and FIG. 4(B) is a diagram illustrating the embodiment of the motion (position or angle) of the imaging device 1 in the front mode.

In the embodiment of the various states of the imaging device 1 illustrated in FIG. 4(A), the imaging of the round mode is determined. For example, the imaging of the round mode is determined for the motion states of the imaging device 1 when the imaging direction (the axis direction) is the upward motion state A-1, and it could be extended to motion state A-2 which is a left incline at forty-five degrees from motion state A-1. It could also be extended to motion state A-3 which is a right incline at forty-five degrees from motion state A-1. In another embodiment, the imaging of the round mode is determined for the motion states of the imaging device 1 when the imaging direction (the axis direction) is the downward motion state A-4, and it could be extended to motion state A-5 which is a right incline of forty-five degrees from motion state A-4, and it could also be extended to motion state A-6 which is a left incline of forty-five degrees from motion state A-4.

On the other hand, in the embodiment of the various motion states of the imaging device 1 illustrated in FIG. 4(B), the imaging of the front mode is determined. For example, the imaging of the front mode is determined for the motion states of the imaging device 1 when the imaging direction (the axis direction) is the rightward motion state B-1, and it could be extended to the motion state B-2 which is an upward incline of forty-five degrees from motion state B-1, and it could also be extended to motion state B-3 which is a downward incline of forty-five degrees from motion state B-1. In another embodiment, the imaging of the front mode is determined for the motion states of the imaging device 1 when the imaging direction (the axis direction) is the leftward motion state B-4, and it could be extended to motion state B-5 which is an upward incline of forty-five degrees from motion state B-4, and it could also be extended to motion state B-6 which is a downward incline of forty-five degrees from motion state B-4.

In other words, when the motion of the imaging device 1 is the same as a direction that is orthogonal to the horizontal direction, the incline's range of forty-five degrees either left or right from the orthogonal direction could be controlled to obtain a picture signal which is omni-directional from the image sensor 12. When the motion of the imaging device 1 is the same as a direction that is consistent with a horizontal direction, the incline range of forty-five degrees either up or down from the horizontal direction can be controlled to obtain a picture signal which belongs in the range determined by the image sensor 12.

### Other Embodiments

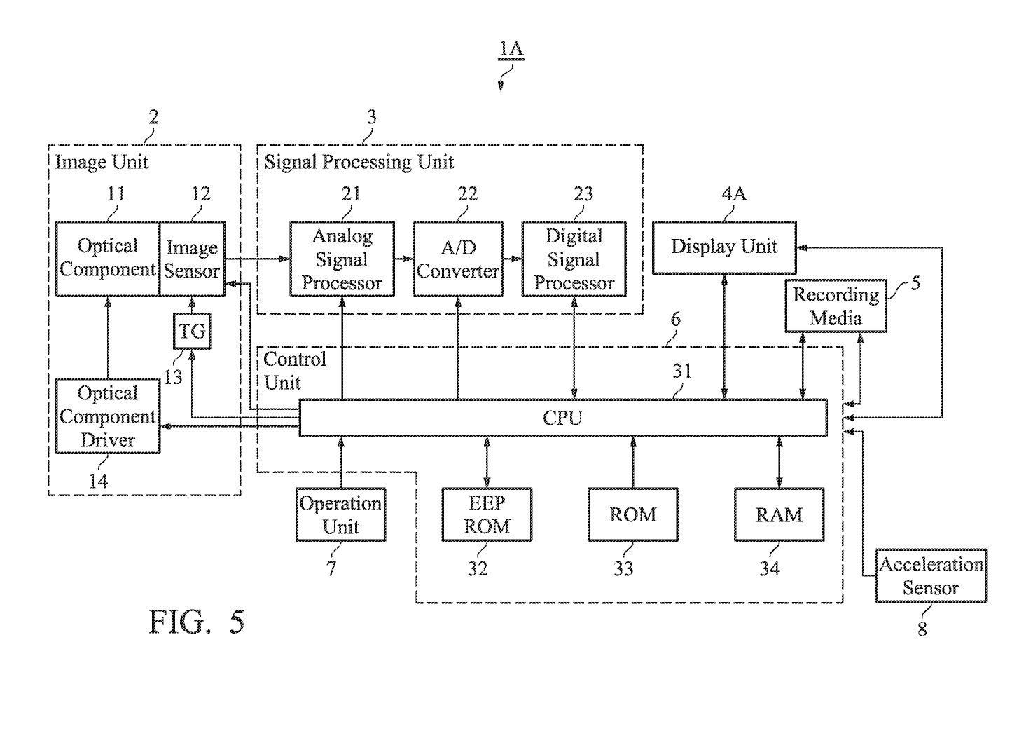

FIG. 5 is a block diagram illustrating the hardware composition of the imaging device 1A according other embodiments of the present invention. The difference between the imaging device 1A of FIG. 5 and the imaging device 1 of FIG. 1 is that the display unit 4 is included by the imaging device 1A itself. Furthermore, other hardware compositions and functions are the same as shown in FIG. 1, and the description for each composition labeled with the same symbol will be ignored. In addition, as shown in FIG. 1, the precondition of transmitting to the external terminal 200 is not illustrated in FIG. 5. In FIG. 5, the display unit 4A is added as a device itself for transmitting signals to the external terminal 200, and it could be utilized just like having the picture displayed on the display unit 201 of the external terminal 200.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An imaging device, comprising:
an image mode determining unit, determining an image mode among a plurality of image modes corresponding to a position or an angle of the imaging device;
a reading range setting unit, setting a reading range for an image sensor corresponding to the determined image mode by the image mode determining unit; and
a control unit, in association with an output of a picture signal which is obtained by optic-electrical conversion from the image sensor according to the reading range based on the setting of the reading range setting unit, temporarily storing pixel data in a frame buffer based on the output picture signal.

2. The imaging device as claimed in claim 1, wherein the imaging device comprises an acceleration sensor, and the position or the angle of the imaging device is obtained by calculation of the acceleration sensor.

3. The imaging device as claimed in claim 2, wherein when the image mode determining unit determines that an imaging direction of the imaging device is orthogonal to a horizontal direction or has the same inclination, the image mode is determined to be an omni-directional mode.

4. The imaging device as claimed in claim 2, wherein when the image mode determining unit determines that an imaging direction of the imaging device is identical to a horizontal direction or has the same inclination, the image mode is determined to be a first mode.

5. The imaging device as claimed in claim 3, wherein when the image mode is determined to be the omni-directional mode, it has the inclination within a range of 45-degree toward left and right inclination in contrast with the orthogonal to the horizontal direction.

6. The imaging device as claimed in claim 4, wherein when the image mode is determined to be the front mode, it has the inclination within a range of 45-degree inclination in contrast with the horizontal direction.

7. The imaging device as claimed in claim 1, wherein the imaging device comprises an operation unit to set the reading range of the image sensor and directly transmit the reading range of the image sensor to the control unit.

8. The imaging device as claimed in claim 7, wherein the image mode could be determined to be the omni-directional mode or the front mode through the operation unit.

9. The imaging device as claimed in claim 1, wherein:
the imaging device comprises a wide-angle lens capable of omni-directional (360-degree) imaging;
the image mode determining unit corresponds to the position or angle of the imaging device; and determines either an omni-directional image mode capable of omni-directional imaging or a usual image mode capable of imaging with a viewing angle that is narrower than that of the omni-directional image mode.

10. The imaging device as claimed in claim 8, wherein the reading range setting unit, when the usual image mode is determined by the image mode determining unit, sets the reading range for a pixel from the image sensor included in a determined range which is narower than an omni-directional viewing angle, and when the omni-directional image mode is determined, maintains the omni-directional viewing angle, and sets the reading range for executing intermittent processing or adding operation so that the data size is the same or approximately the same as the data size determined by the reading range of the usual image mode.

11. The imaging device as claimed in claim 9, wherein the control unit, in association with an output of the picture signal which is obtained by optic-electrical conversion from the image sensor according to the setting of the reading range setting unit, temporarily stores the pixel data in the frame buffer based on the output picture signal.
